(19) United States
(12) Patent Application Publication
(10) Pub. No.: US 2019/0171913 A1
(43) Pub. Date: Jun. 6, 2019

(54) HIERARCHICAL CLASSIFICATION USING NEURAL NETWORKS

(71) Applicant: Slice Technologies, Inc., San Mateo, CA (US)

(72) Inventors: Minhao Cheng, Davis, CA (US); Xiaocheng Tang, San Mateo, CA (US); Chu-Cheng Hsieh, San Jose, CA (US)

(73) Assignee: Slice Technologies, Inc., San Mateo, CA (US)

(21) Appl. No.: 15/831,382

(22) Filed: Dec. 4, 2017

(51) Int. Cl. G06K 9/62; G06N 3/04

(52) U.S. Cl. CPC G06K 9/6282; G06N 3/04

(57) ABSTRACT

Methods, systems, apparatus, and tangible non-transitory carrier media encoded with one or more computer programs for classifying an input text block into a sequence of one or more classes in a multi-level hierarchical classification taxonomy. In accordance with particular embodiments, a source sequence of inputs corresponding to the input text block is processed, one at a time per time step, with an encoder recurrent neural network (RNN) to generate a respective encoder hidden state for each input, and the respective encoder hidden states are processed, one at a time per time step, with a decoder RNN to produce a sequence of outputs representing a directed classification path in a multi-level hierarchical classification taxonomy for the input text block.

### BACKGROUND

Hierarchical classification involves mapping input data into a taxonomic hierarchy of output classes. Many hierarchical classification approaches have been proposed. Examples include “flat” approaches, such as the one-against-one and the one-against-all schemes, which ignore the hierarchical structure and, instead, treat hierarchical classification as a multiclass classification problem that involves learning a binary classifier for all non-root nodes. Another approach is the “local” classification approach, which involves training a multiclass classifier locally at each node, each parent node, or each level in the hierarchy. A fourth common approach is the “global” classification approach, which involves training a global classifier to assign each item to one or more classes in the hierarchy by considering the entire class hierarchy at the same time.

An artificial neural network (referred to herein as a “neural network”) is a machine learning system that includes one or more layers of interconnected processing elements that collectively predict an output for a given input. A neural network includes an output layer and one or more optional hidden layers, each of which produces an output that is input into the next layer in the network. Each processing unit in a layer processes an input in accordance with the values of a current set of parameters for the layer.

A recurrent neural network (RNN) is configured to produce an output sequence from an input sequence in a series of time steps. A recurrent neural network includes memory blocks that maintain an internal state for the recurrent neural network. Some or all of the internal state of the recurrent neural network that is updated in a preceding time step can be used to compute an output in a current time step. For example, some recurrent neural networks include units of cells that have respective gates that allow the units to store the states in the preceding time step. Examples of such cells include Long Short-Term Memory (LSTM) cells and Gated Recurrent Units (GRUs).

### SUMMARY

This specification describes systems implemented by one or more computers executing one or more computer programs that can classify an input text block according to a taxonomic hierarchy using neural networks (e.g., one or more recurrent neural networks (RNNs), LSTM neural networks, and/or GRU neural networks).

Embodiments of the subject matter described herein include methods, systems, apparatus, and tangible non-transitory carrier media encoded with one or more computer programs for classifying an input text block into a sequence of one or more classes in a multi-level hierarchical classification taxonomy. In accordance with particular embodiments, a source sequence of inputs corresponding to the input text block is processed, one at a time per time step, with an encoder recurrent neural network (RNN) to generate a respective encoder hidden state for each input, and the respective encoder hidden states are processed, one at a time per time step, with a decoder RNN to produce a sequence of outputs representing a directed classification path in a multi-level hierarchical classification taxonomy for the input text block.

Embodiments of the subject matter described herein can be used to overcome the above-mentioned limitations in the prior classification approaches and thereby achieve the following advantages. Recurrent neural networks can be used for classifying input text blocks according to a taxonomic hierarchy by modeling complex relations between input words and node sequence paths through a taxonomic hierarchy. In this regard, recurrent neural networks are able to learn the complex relationships between natural language input text and the nodes in a taxonomic hierarchy that define a classification path without needing a separate local classifier at each node or each level in a taxonomic hierarchy or a global classifier that considers the entire class hierarchy at the same time, as required in other approaches.

Other features, aspects, objects, and advantages of the subject matter described in this specification will become apparent from the description, the drawings, and the claims.

### DESCRIPTION OF DRAWINGS

FIG. 1 is a diagrammatic view of an example taxonomic hierarchy of nodes corresponding to a tree.

FIG. 2 is a diagrammatic view of an example of a neural network system for generating a sequence of outputs representing a path in a taxonomic hierarchy from a sequence of inputs.

FIG. 3 is a flow diagram of an example process for generating a sequence of outputs representing a path in a taxonomic hierarchy from a sequence of inputs.

FIG. 4 is a block diagram of an example encoder-decoder neural network system.

FIG. 5A is a diagrammatic view of an example directed path of nodes in the example taxonomic hierarchy of nodes shown in FIG. 1.

FIG. 5B shows a sequence of inputs corresponding to an item description being mapped to a sequence of output classes corresponding to nodes in the example classification path shown in FIG. 5A.

FIG. 6 is a diagrammatic view of an example taxonomic hierarchy of nodes.

FIG. 7 is a block diagram of an example hierarchical classification system that includes an attention module.

FIG. 8 is a flow diagram of an example attention process.

FIG. 9 is a block diagram of an example computer apparatus.

### DETAILED DESCRIPTION

In the following description, like reference numbers are used to identify like elements. Furthermore, the drawings are intended to illustrate major features of exemplary embodiments in a diagrammatic manner. The drawings are not intended to depict every feature of actual embodiments nor relative dimensions of the depicted elements, and are not drawn to scale.

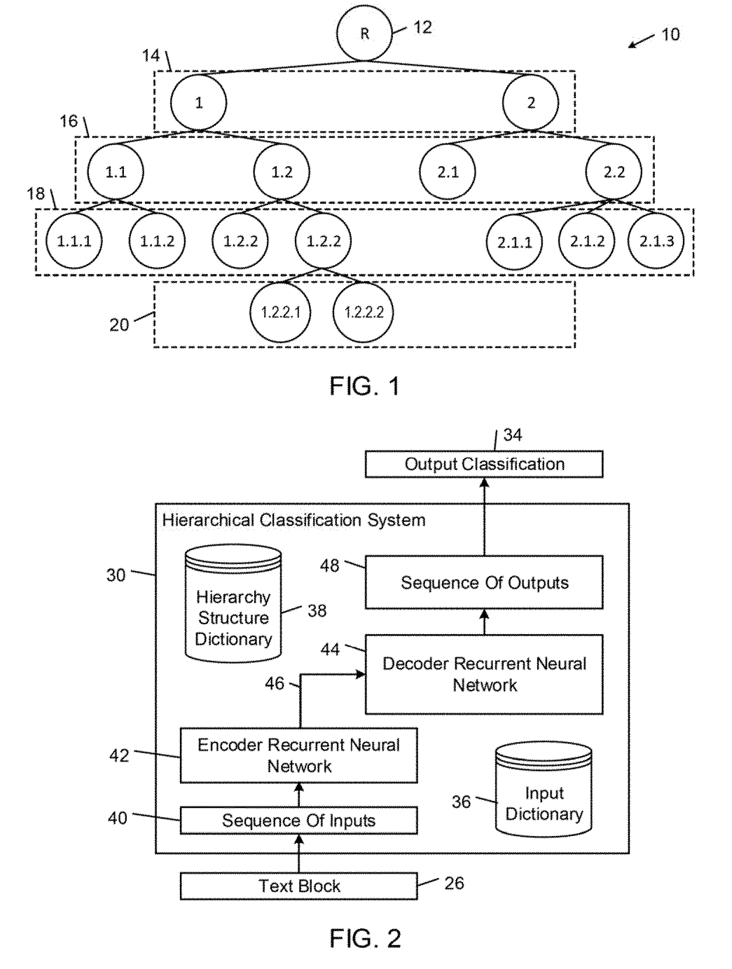

FIG. 1 shows an example taxonomic hierarchy 10 arranged as a tree structure that has one root node 12 and a plurality of non-root nodes, where each non-root node is connected by a directed edge from exactly one other node. Terminal non-root nodes are referred to as leaf nodes (or leaves) and the remaining non-root nodes are referred to as internal nodes. The tree structure is organized into levels 14, 16, 18, and 20 according to the depth of the non-root nodes from the root node 12, where nodes at the same depth are in the same level in the taxonomic hierarchy. Each non-root node represents a respective class in the taxonomic hierarchy. In other examples, a taxonomic hierarchy may be arranged as a directed acyclic graph.

In general, the taxonomic hierarchy 10 can be used to classify many different types of data into different taxonomic classes, from one or more high-level broad classes, through progressively narrower classes, down to the leaf node level classes. However, traditional hierarchical classification methods, such as those mentioned above, either do not take parent-child connections into account or only indirectly exploit those connections; consequently, these methods have difficulty achieving high generalization performance. As a result, there is a need for a new approach for classifying inputs according to a taxonomic hierarchy of classes that is able to fully leverage the parent-child node connections to improve classification performance.

FIG. 2 shows an example hierarchical classification system 30 that is implemented as one or more computer programs on one or more computers that may be in the same or different locations. The hierarchical classification system 30 is trained to process an input text block 32 to produce an output classification 34 in accordance with a taxonomic hierarchy. Each input text block 32 is a sequence of one or more natural language words of alphanumeric characters and optionally one or more punctuation marks or symbols (e.g., &, %, $, #, @, and *). The output classification 34 for a given input text block 26 also is a sequence of one or more natural language words that may include one or more punctuation marks or symbols. In general, the input text block 32 and the output classification 34 can be sequences of varying and different lengths.

The hierarchical classification system 30 includes an input dictionary 36 that includes all the unique words that appear in a corpus of possible input text blocks. The collection of unique words corresponds to an input vocabulary for the descriptions of items to be classified according to a taxonomic hierarchy. In some examples, the input dictionary 36 also includes one or more of a start-of-sequence symbol (e.g., <sos>), an end-of-sequence symbol (e.g., <eos>), and an unknown word token that represents unknown words.

The hierarchical classification system 30 also includes a hierarchy structure dictionary 38 that includes a listing of the nodes of a taxonomic hierarchy and their respective the class labels each of which consists of one or more words. The unique words in the set of class labels correspond to an output vocabulary for the node classes into which the item descriptions can be classified according to the taxonomic hierarchy.

In some examples, the words in the input dictionary 36 and the class labels in hierarchy structure dictionary 38 are encoded with respective indices. During training of the hierarchical classification sequential model, embeddings are learned for the encoded words in the input dictionary 36 and the class labels in the hierarchy structure dictionary 38. The embeddings are dense vectors that project the words in the input dictionary 36 and the class labels in hierarchy structure dictionary 38 into a learned continuous vector space. In an example, an embedding layer is used to learn the word embeddings for all the words in the input dictionary 36 and the class labels in the hierarchy structure dictionary 38 at the same time the hierarchical classification system 30 is trained. The embedding layer can be initialized with random weights or it can be loaded with a pre-trained embedding model. The input dictionary 36 and the hierarchy structure dictionary 38 store respective mappings between the word representations of the input words and class labels and their corresponding word vector representations.

The hierarchical classification system 30 converts the sequence of words in the input text block 26 into a sequence of inputs 40 by replacing the input words (and optionally the input punctuation marks and/or symbols) with their respective word embeddings based on the mappings stored in the input dictionary 36. In some examples, the hierarchical classification system 30 also brackets the input word embedding sequence between one or both of the start-of-sequence symbol and the end-of-sequence symbol.

The hierarchical classification system 30 includes an encoder recurrent neural network 42 and a decoder recurrent neural network 44. In general, the encoder and decoder neural networks 42, 44 may include one or more vanilla recurrent neural networks, Long Short-Term Memory (LSTM) neural networks, and Gated Recurrent Unit (GRU) neural networks.

In one example, the encoder recurrent neural network 42 and the decoder recurrent neural network 44 are each implemented by a respective LSTM neural network. In this example, each of the encoder and decoder LSTM neural networks includes one or more LSTM neural network layers, each of which includes one or more LSTM memory blocks of one or more memory cells, each of which includes an input gate, a forget gate, and an output gate that enable the cell to store previous activations of the cell, which can be used in generating a current activation or used by other elements of the LSTM neural network. The encoder LSTM neural network processes the inputs in the sequence 40 in a particular order (e.g., in input order or reverse input order) and, in accordance with its training, the encoder LSTM neural network updates the current hidden state 46 of the encoder LSTM neural network based on results of processing the current input in the sequence 40. The decoder LSTM neural network 42 processes the encoder hidden states 46 for the inputs in the sequence 40 to generate a sequence of outputs 48.

In another example, the encoder recurrent neural network 42 and the decoder recurrent neural network 44 are each implemented by a respective GRU neural network. In this example, each of the encoder and decoder GRU neural networks includes one or more GRU neural network layers, each of which includes one or more GRU blocks of one or more cells, each of which includes a reset gate that controls how the current input is combined with the data previously stored in memory and an update gate that controls the amount of the previous memory that is stored by the cell, where the stored memory can be used in generating a current activation or used by other elements of the GRU neural network. The encoder GRU neural network processes the inputs in the sequence 40 in a particular order (e.g., in input order or reverse input order) and, in accordance with its training, the encoder GRU neural network updates the current hidden state 46 of the encoder GRU neural network based on results of processing the current input in the sequence 40. The decoder GRU neural network processes the encoder hidden states 46 for the inputs in the sequence 40 to generate a sequence of outputs 48.

Thus, as part of producing an output classification 34 from an input text block 26, the hierarchical classification system 30 processes the sequence 40 of inputs using the encoder recurrent neural network 42 to generate a respective encoder hidden state 46 for each input in the sequence 40 of inputs. The hierarchical classification system 30 processes the encoder hidden states using the decoder recurrent neural network 44 to produce a sequence of outputs 48. The outputs in the sequence 48 correspond to respective word embeddings (also referred to as “word vectors”) for the class labels associated with the nodes of the taxonomic hierarchy listed in the hierarchy structure dictionary 38. Thus, for every input word in the text block, the encoder recurrent neural network 42 outputs a respective word vector and a respective hidden state 46. The encoder recurrent neural network 42 uses the hidden state 46 for processing the next input word. The decoder recurrent neural network 44 processes the final hidden state of the encoder recurrent neural network to produce the sequence 48 of outputs. The hierarchical classification system 30 converts the sequence of outputs 48 into an output classification 34 by replacing one or more of the output word embeddings in the sequence of outputs 48 with their corresponding natural language words in the output classification 34 based on the mappings between the word vectors and the node class labels that are stored in the hierarchy structure dictionary 38.

The output classification 34 for a given input text block 26 typically corresponds to one or more class labels in a taxonomic hierarchy structure. In some examples, the output classification 34 corresponds to a single class label that is associated with a leaf node in the taxonomic hierarchy structure; this class label corresponds to the last output in the sequence 48. In some examples, the output classification 34 corresponds to a sequence of class labels associated with multiple nodes that define a directed path of nodes in the taxonomic hierarchy structure. In some examples, the output classification 34 for a given input text block 26 corresponds to the class labels associated with the one or more of the nodes in multiple directed paths of nodes in the taxonomic hierarchy structure. In some examples, the output classification 34 for a given input text block 26 corresponds to a classification path that includes multiple nodes at the same level (e.g., the leaf node level) in the taxonomic hierarchy structure (i.e., a multi-label classification).

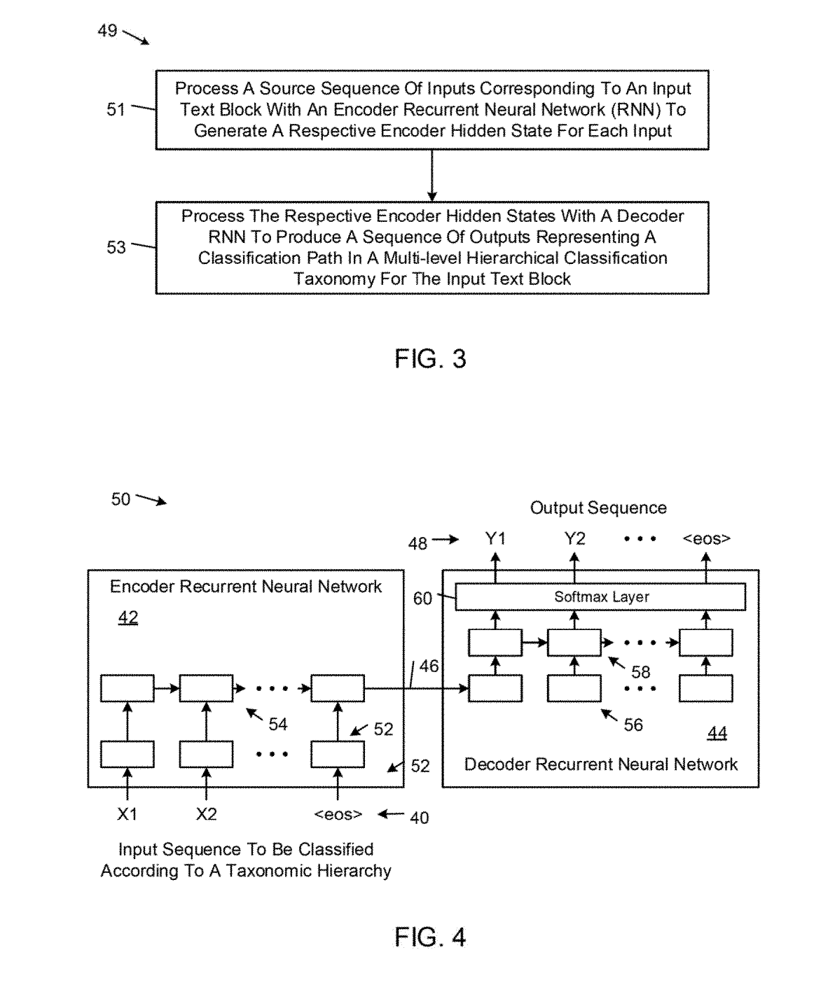

FIG. 3 is a flow diagram of an example process 49 of producing an output classification 34 for a given input text block 26 in accordance with a taxonomic hierarchy. The hierarchical classification system 30 described above in connection with FIG. 2 is an example of a system that can perform the process 49.

The hierarchical classification system 30 processes a source sequence 40 of inputs corresponding to an input text block 26 with an encoder recurrent neural network 42 to generate a respective encoder hidden state for each input (step 51). In this regard, the hierarchical classification system 30 processes the sequence 40 of inputs using the encoder recurrent neural network 42 to generate a respective encoder hidden state 46 for each input in the sequence of inputs 40, where the hierarchical classification system 30 updates a current hidden state of the encoder recurrent neural network 42 at each time step.

The hierarchical classification system 30 processes the respective encoder hidden states with a decoder recurrent neural network 44 to produce a sequence 48 of outputs representing a classification path in a hierarchical classification taxonomy for the input text block 26 (step 53). In particular, the hierarchical classification system 30 processes the encoder hidden states using the decoder recurrent neural network 44 to generate scores for the outputs (which correspond to respective nodes in the taxonomic hierarchy structure) for the next position in the output order. The hierarchical classification system 30 then selects an output for the next position in the output order for the sequence 48 based on the output scores. In an example, the hierarchical classification system 30 selects the output with the highest score as the output for the next position in the current sequence 48 of outputs.

FIG. 4 shows an example neural network system 50 that can be used in the example hierarchical classification system 30 to transduce a sequence 40 of inputs (e.g., X1, X2, . . . , XM) into a sequence 48 of outputs (e.g., Y1, Y2, . . . , YN) corresponding to a structured classification path of nodes in a taxonomic hierarchy (e.g., taxonomic hierarchy 10). In this example, the encoder recurrent neural network 42 includes two hidden neural network layers 52 and 54, and the decoder recurrent neural network 44 includes two hidden neural network layers 56 and 58. Other examples of the encoder and decoder recurrent neural networks 42, 44 can include different numbers of hidden neural network layers with the same or different configurations. For example, the layers in the encoder and decoder recurrent neural networks 42, 44 can be implemented by one or more LSTM neural network layers and/or GRU neural network layers. The encoder recurrent neural network 42 transforms each input in the input sequence 40 into a respective encoder hidden state until an end-of-sequence symbol (e.g., <eos>) is reached. After the end-of-sequence symbol has been processed or a pre-set stop criterion has been triggered (for example, a lower bound of a confidence measurement accompanying each node), the encoder recurrent network 42 outputs the encoder hidden states 46 to the decoder recurrent neural network 44. The decoder recurrent neural network 44 processes the encoder hidden states 46 through the hidden decoder neural network layers 56, 58. The decoder recurrent neural network 44 includes a softmax layer 60 that uses the encoder hidden states 46 to calculate scores for all the outputs (e.g., class labels) in the hierarchy structure dictionary 38 at each time step. Each output score for a respective output corresponds to the likelihood that the output is the next symbol for the next position in the current sequence 48 of outputs. For each time step, the decoder recurrent neural network 44 emits a respective output in the sequence 48, one output at a time, until the end-of-sequence symbol is produced. The decoder recurrent neural network 44 also updates its current hidden state at each time step.

Thus, in accordance with its training, the hierarchical classification system 30 is operable to receive a sequence 40 of natural language text inputs and produce, at each time step, a respective output in a structured sequence 48 of outputs that correspond to the class labels of respective nodes in an ordered sequence that defines a directed classification path through the taxonomic hierarchy. In particular, the output sequence 48 is structured by the parent-child relations between the nodes that induce subset relationships between the corresponding parent-child classes, where the classification region of each child class is a subset of the classification region of its respective parent class. As a result, direct and indirect relations among the nodes over the taxonomic hierarchy impose an inter-class relationship among the classes in the sequence 48 of outputs.

In some examples, the hierarchical classification system 30 incorporates rules that guide the selection of transitions between nodes in the hierarchical taxonomic structure. In some of these examples, a domain expert for the subject matter being classified defines the node transition rules. In one example, for each of one or more positions in the output order (corresponding to one or more nodes in the hierarchical taxonomic structure), the hierarchical classification system 30 restricts the selection of the respective output to a respective subset of available class nodes in the hierarchical structure designated in a white list of allowable class nodes associated with the current output (i.e., the output predicted in the preceding time step). In another example, for each of one or more positions in the output order, the selecting comprises refraining from selecting the respective output from a respective subset of available class nodes in the hierarchical structure designated in a black list of disallowed class nodes associated with the current output (i.e., the output predicted in the preceding time step).

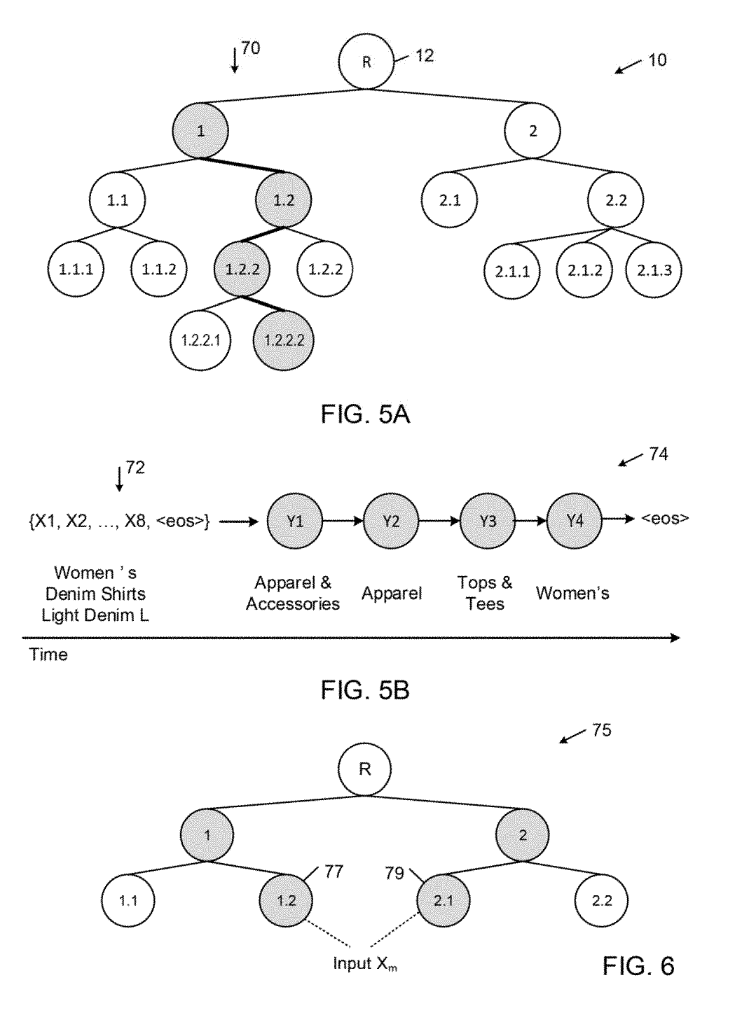

FIG. 5A shows an example structured classification path 70 of non-root nodes in the tree structure of the taxonomic hierarchy 10. The structured classification path 70 of nodes consists of an ordered sequence of the nodes 1, 1.2, 1.2.2, and 1.2.2.2. In this example, each non-root node corresponds to a different respective level in the taxonomic hierarchy 10.

Referring to FIG. 5B, the hierarchical classification system 30 is trained to process a sequence 72 of inputs {X1, X2, . . . , X8}, one at a time per time step, and then produce a sequence 74 of outputs {Y1, Y2, . . . , Y4} corresponding to a sequence of the nodes in the structured hierarchical classification path 70, one at a time per time step. In this example, the sequence 72 of inputs corresponds to a description of a product (i.e., “Women's Denim Shirts Light Denim L”) and the taxonomic hierarchy 10 defines a hierarchical product classification system. In the illustrated example, the hierarchical classification system 30 has transduced the sequence 72 of inputs {X1, X2, . . . , X8} into the directed hierarchical sequence of output node class labels {“Apparel & Accessories”, “Apparel”, “Tops & Tees”, “Women's”}.

In some examples, the hierarchical classification system 30 provides the output classification 34 as input to another system for additional processing. For example, in the product classification example shown in FIGS. 5A and 5B, the hierarchical classification system can provide the output classification 34 as input to a deep categorization system that determines the deepest category node that an item maps to, or as an input to a brand extraction system that extracts the brand and/or sub-brand data associated with an item.

In addition to learning a single discrete classification path through a hierarchical classification structure for each input sequence 40, examples of the hierarchical classification system 30 also can be trained to classify an input Xₘ into multiple paths in a hierarchical classification structure (i.e., a multi-label classification). For example, FIG. 6 shows an example in which the input Xₘ is mapped to two nodes 77, 79 that correspond to different classes and two different paths in a taxonomic hierarchy structure 75. Techniques similar to those described below can be used to train the hierarchical classification system 30 to generate an output classification 34 that captures all the class labels associated with an input.

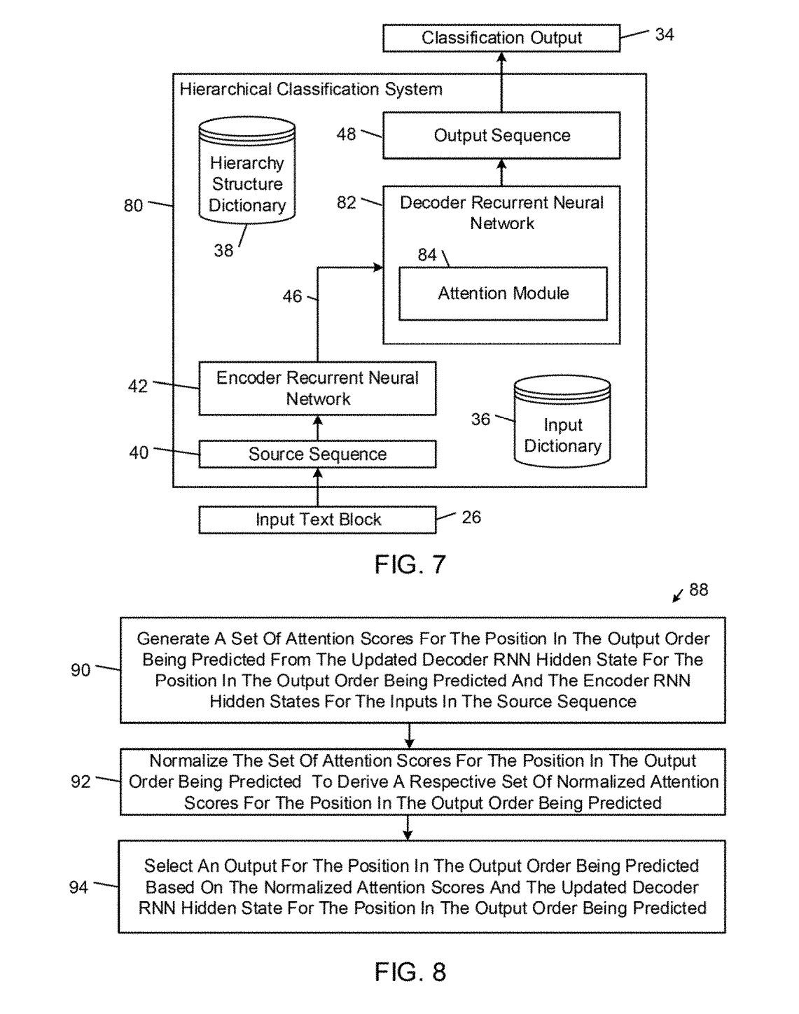

FIG. 7 shows an example 80 hierarchical classification system 30 that is implemented as one or more computer programs on one or more computers that may be in the same or different locations. In this example, the decoder recurrent neural network 82 incorporates an attention module 84 that can focus the decoder recurrent neural network 82 on different regions of the source sequence 40 during decoding.

FIG. 8 shows an example process 88 that is performed by the attention module 84 to select a sequence 48 of outputs that correspond to respective nodes that define a structured classification path of nodes in a taxonomic hierarchy. In accordance with this method, a set of attention scores are generated for the position in the output order being predicted from the updated decoder recurrent neural network hidden state for the position in the output order being predicted and the encoder recurrent neural network hidden states for the inputs in the source sequence (block 90). The set of attention scores for the position in the output order being predicted are normalized to derive a respective set of normalized attention scores for the position in the output order being predicted (FIG. 7, block 92). An output is selected for the position in the output order being predicted based on the normalized attention scores and the updated decoder recurrent neural network hidden state for the position in the output order being predicted (block 94).

For each position in the output sequence 48, the attention module 84 configures the decoder recurrent neural network 82 to generate an attention vector (or attention layer) over the encoder hidden states 46 based on the current output (i.e., the output predicted in the preceding time step) and the encoder hidden states. In some examples, the hierarchical classification system 80 uses a predetermined placeholder symbol (e.g., the start-of-sequence symbol, i.e., “<sos>”) for the first output position. In examples in which the inputs to the encoder recurrent neural network are presented in reverse order, the hierarchical classification system initializes the current hidden state of the decoder recurrent neural network 82 for the first output position with the final hidden state of the encoder recurrent neural network 42. The decoder recurrent neural network 82 processes the attention vector, the output of the encoder, and the values of the previous nodes predicted to generate scores for the next position to be predicted (i.e., for the nodes that are defined in the hierarchy structure dictionary 38 and are associated with class labels in the taxonomic hierarchy 10). The hierarchical classification system 80 then uses the output scores to select an output 48 (e.g., the output with the highest output score) for the next position from the set of nodes in the hierarchy structure dictionary 38. The hierarchical classification system 80 selects outputs 48 for the output positions until the end-of-sequence symbol (e.g., “<eos>”) is selected. The hierarchical classification system 80 generates the classification output 34 from the selected outputs 48 excluding the start-of-sequence and end-of-sequence symbols. In this process, the hierarchical classification system 80 maps the output word vector representations of the nodes to the corresponding class labels in the taxonomic hierarchy 10.

The hierarchical classification system 80 processes a current output (e.g., “<sos>”) for the first output position or the output in the position that precedes the output position to be predicted) through one or more decoder recurrent neural network layers to update the current state of the decoder recurrent neural network 82. In some examples, the hierarchical classification system 80 generates an attention vector of respective scores for the encoder hidden states based on a combination of the hidden states of encoder recurrent neural network and the updated decoder hidden state for the output position to be predicted. In some examples, the attention scoring function that compares the encoder and decoder hidden states can include one or more of: a dot product between states; a dot product between the decoder hidden states and a linear transform of the encoder state; or a dot product between a learned parameter and a linear transform of the states concatenated together. The hierarchical classification system 80 then normalizes the attention scores to generate the set of normalized attention scores over the encoder hidden states.

In some examples, a general form of the attention model is a variable length alignment vector aₜ(s) that has a length equal to the number of time steps on the encoder side and is derived by comparing the current decoder hidden state hₜ with the encoder hidden state h̅ₛ:

$$\begin{matrix}{a}_{t} ( s ) = align ( {h}_{t} , {\overline{h}}_{s} ) \\ = \frac{exp ( score ( {h}_{t} , {\overline{h}}_{s} ) )}{{\sum }_{{s}^{′}} exp ( score ( {h}_{t} , {\overline{h}}_{s} ) )}\end{matrix}$$

where score( ) is a content-based function, such as one of the following three different functions for combining the current decoder hidden state hₜ with the encoder hidden state h̅ₛ:

$$score ( {h}_{t} , {\overline{h}}_{s} ) = \{ \begin{matrix}{h}_{t}^{⊤} {\overline{h}}_{s} \\ {h}_{t}^{⊤} {W}_{a} {\overline{h}}_{s} \\ {v}_{a}^{⊤} tanh ( {W}_{a} ( {h}_{t}^{⊤} ; {\overline{h}}_{s} ) )\end{matrix}$$

The vector vₐ^{T} and the parameter matrix Wₐ are learnable parameters of the attention model. The alignment vector aₜ(s) consists of scores that are respectively applied to obtain the weighted average over all the encoder hidden states to generate a global encoder side context vector cₜ(s). The context vector cₜ(s) is combined with the decoder hidden state to obtain an attentional vector \tilde{h}ₜ, according to:

\tilde{h}ₜ=tan h(W_{c}[cₜ;hₜ]).

The parameter matrix W_{c} is a learnable parameter of the attention model. The attentional vector \tilde{h}ₜ is input into a softmax function to produce a predictive distribution of scores for the outputs. For additional details regarding the example attention model described above, see Minh-Thang Luong et al., “Effective approaches to attention based neural machine translation,” In Proc. of EMNLP, Sep. 20, 2015.

In general, the hierarchical classification systems described herein (e.g., the hierarchical classification systems 30 and 80 shown in FIGS. 3 and 8) are operable to perform the processes 49 and 88 (respectively shown in FIGS. 3 and 8) to classify known input text blocks 26 during training and to classify unknown input text blocks 26 during classification. In particular, during training, the hierarchical classification systems 30 and 80 respectively perform the processes 49 and 88 on text blocks in a set of known training data to train the encoder recurrent neural network 42 and the decoder neural networks 44 and 82. In this regard, the hierarchical classification system 30 determines trained values for the parameters of the encoder recurrent neural network 42 and the decoder neural network 44, and the hierarchical classification system 80 determines trained values for the parameters of the encoder recurrent neural network 42 and the decoder neural network 82 (including the attention module 84). The training processes may be performed in accordance with conventional machine learning training techniques including, for example, back propagating the loss and using dropout to prevent overfitting.

The following is a summary of an example process for training the hierarchical classification systems 30 and 80. The input and hierarchy structure vocabularies, including the start-of-sequence, end-of-sequence, and unknown word symbols, are respectively loaded into the input dictionary 30 and the hierarchical structure dictionary 38 and associated with respective indices. A training input text block (e.g., an item description) is transformed into a set of one or more indices according to the input dictionary 36 and associated with a respective set of one or more random word embeddings. The hierarchical classification system passes the set of word embeddings, one at a time, into the encoder recurrent network 42 to obtain a final encoder hidden state for the inputs in the source sequence 40. In the example hierarchical classification system 30, the decoder recurrent neural network 44 initializes its hidden state with the final hidden state of the encoder recurrent neural network 42 and, for each time step, the decoder neural network 44 uses a multi-class classifier (e.g., a softmax layer or a support vector machine) to generate respective scores for the outputs in the hierarchy structure dictionary 38 for the next position in the output order. In the example hierarchical classification system 80, for each time step, the decoder neural network 82 generates an attentional vector from a weighted average over the final hidden states of the encoder recurrent neural network 42, where the weights are derived from the final hidden states of the encoder recurrent neural network 42 and the current decoder hidden state, and the decoder neural network 82 uses a multi-class classifier (e.g., a softmax layer or a support vector machine) to process the attentional vector and generate respective predictive scores for the outputs. In one mode of operation, each example hierarchical classification system 30, 80 selects, for each input text block 26, a single output corresponding to node in the taxonomic hierarchy (e.g., the leaf node associated with the highest predicted probability), converts the output embedding for the selected output into text corresponding to a class label in the hierarchy structure dictionary 38, and produces the text as the output classification 34. In a beam search mode of operation, each example hierarchical classification system 30, 80 performs beam search decoding to select multiple sequential node paths through the taxonomic hierarchy (e.g., a set of paths having the highest predicted probabilities). In some examples, the hierarchical classification system outputs the class labels associated with leaf nodes in the node paths selected in the beam search.

The result of training any of the hierarchical classification systems described in this specification is a trained neural network classification model that includes a neural network trained to map an input text block 26 to an output classification 34 according to a taxonomic hierarchy of classes. In general, the neural network classification model can be any recurrent neural network classification model, including a plain vanilla recurrent neural network, a LSTM recurrent neural network, and a GRU recurrent neural network. An example neural network classification model includes an encoder recurrent neural network and a decoder recurrent neural network, where the encoder recurrent neural network is operable to process an input text block 26, one word at a time, to produce a hidden state that summarizes the entire text block 26, and the decoder recurrent neural network is operable to be initialized by a final hidden state of the encoder recurrent neural network and operable to generate, one output at a time, a sequence of outputs corresponding respective class labels of respective nodes defining a directed path in the taxonomic hierarchy.

Examples of the subject matter described herein, including the disclosed systems, methods, processes, functional operations, and logic flows, can be implemented in data processing apparatus (e.g., computer hardware and digital electronic circuitry) operable to perform functions by operating on input and generating output. Examples of the subject matter described herein also can be tangibly embodied in software or firmware, as one or more sets of computer instructions encoded on one or more tangible non-transitory carrier media (e.g., a machine readable storage device, substrate, or sequential access memory device) for execution by data processing apparatus.

The details of specific implementations described herein may be specific to particular embodiments of particular inventions and should not be construed as limitations on the scope of any claimed invention. For example, features that are described in connection with separate embodiments may also be incorporated into a single embodiment, and features that are described in connection with a single embodiment may also be implemented in multiple separate embodiments. In addition, the disclosure of steps, tasks, operations, or processes being performed in a particular order does not necessarily require that those steps, tasks, operations, or processes be performed in the particular order; instead, in some cases, one or more of the disclosed steps, tasks, operations, and processes may be performed in a different order or in accordance with a multi-tasking schedule or in parallel.

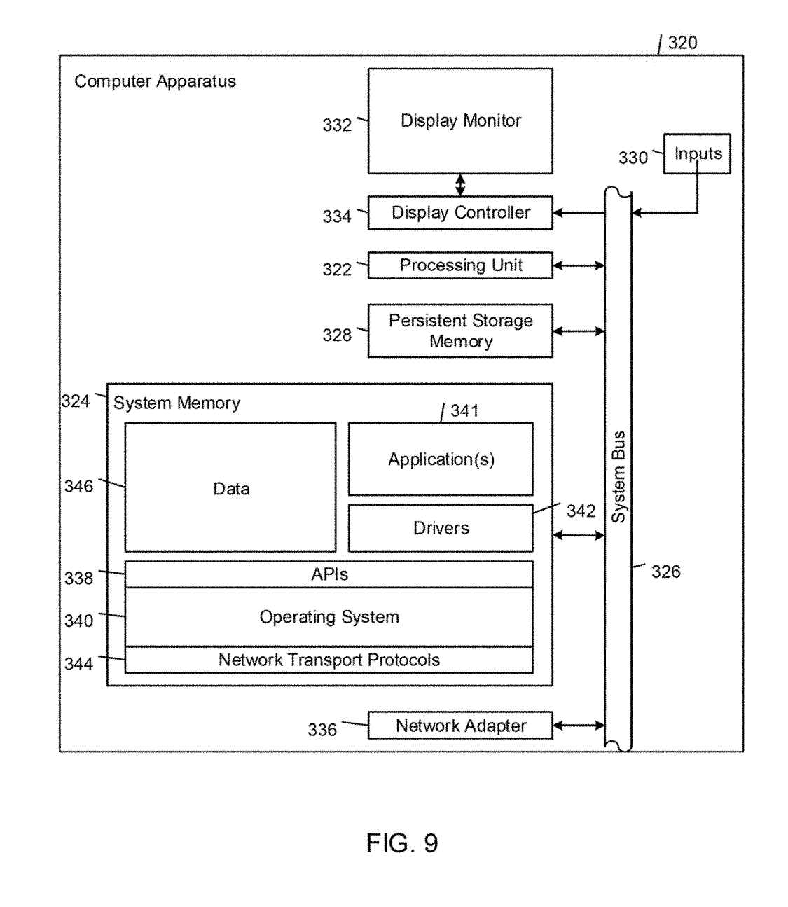

FIG. 9 shows an example embodiment of computer apparatus that is configured to implement one or more of the hierarchical classification systems described in this specification. The computer apparatus 320 includes a processing unit 322, a system memory 324, and a system bus 326 that couples the processing unit 322 to the various components of the computer apparatus 320. The processing unit 322 may include one or more data processors, each of which may be in the form of any one of various commercially available computer processors. The system memory 324 includes one or more computer-readable media that typically are associated with a software application addressing space that defines the addresses that are available to software applications. The system memory 324 may include a read only memory (ROM) that stores a basic input/output system (BIOS) that contains start-up routines for the computer apparatus 320, and a random access memory (RAM). The system bus 326 may be a memory bus, a peripheral bus or a local bus, and may be compatible with any of a variety of bus protocols, including PCI, VESA, Microchannel, ISA, and EISA. The computer apparatus 320 also includes a persistent storage memory 328 (e.g., a hard drive, a floppy drive, a CD ROM drive, magnetic tape drives, flash memory devices, and digital video disks) that is connected to the system bus 326 and contains one or more computer-readable media disks that provide non-volatile or persistent storage for data, data structures and computer-executable instructions.

A user may interact (e.g., input commands or data) with the computer apparatus 320 using one or more input devices 330 (e.g. one or more keyboards, computer mice, microphones, cameras, joysticks, physical motion sensors, and touch pads). Information may be presented through a graphical user interface (GUI) that is presented to the user on a display monitor 332, which is controlled by a display controller 334. The computer apparatus 320 also may include other input/output hardware (e.g., peripheral output devices, such as speakers and a printer). The computer apparatus 320 connects to other network nodes through a network adapter 336 (also referred to as a “network interface card” or NIC).

A number of program modules may be stored in the system memory 324, including application programming interfaces 338 (APIs), an operating system (OS) 340 (e.g., the Windows® operating system available from Microsoft Corporation of Redmond, Wash. U.S.A.), software applications 341 including one or more software applications programming the computer apparatus 320 to perform one or more of the steps, tasks, operations, or processes of the hierarchical classification systems described herein, drivers 342 (e.g., a GUI driver), network transport protocols 344, and data 346 (e.g., input data, output data, program data, a registry, and configuration settings).

Other embodiments are within the scope of the claims.

1. A classification method performed by one or more computers, the method comprising:
processing a source sequence of inputs corresponding to an input text block with an encoder recurrent neural network (RNN) to generate a respective encoder hidden state for each input;
processing the respective encoder hidden states with a decoder RNN to produce a sequence of outputs representing a classification path in a multi-level hierarchical classification taxonomy for the input text block.

2. The method of claim 1, wherein the sequence of outputs is selected, in an output order, from a predetermined vocabulary of outputs representing respective class nodes in a rooted tree representation of the multi-level hierarchical classification taxonomy.

3. The method of claim 2, wherein each output to be predicted at each successive position in the output order corresponds to a respective successive level in the hierarchical classification taxonomy.

4. The method of claim 2, wherein processing the respective encoder hidden states is performed without regard to any explicit interclass relationships between the class nodes in the multi-level hierarchical classification taxonomy.

5. The method of claim 2, wherein processing the respective encoder hidden states comprises, for each position in the output order, producing a decoder hidden state for the position with the decoder RNN and processing the encoder hidden states and the decoder hidden state to generate a set of output scores for the outputs in the predetermined vocabulary.

6. The method of claim 5, further comprising, for each position in the output order, selecting a respective output in the predetermined vocabulary based on the output scores.

7. The method of claim 6, wherein, for each position in the output order, the selecting comprises restricting the selection of the respective output to a respective subset of available class nodes in the rooted tree identified in a white list of allowable class nodes associated with the preceding output.

8. The method of claim 6, wherein, for each position in the output order, the selecting comprises refraining from selecting the respective output from a respective subset of available class nodes in the rooted tree identified in a black list of disallowed class nodes associated with the preceding output.

9. The method of claim 5, further comprising, for each position in the output order:
processing the current output with the decoder RNN to generate an updated decoder RNN hidden state for the position in the output order;
generating a set of attention scores for the position from the updated decoder RNN hidden state for the position and the encoder RNN hidden states for the inputs in the source sequence;
normalizing the set of attention scores for the position to derive a respective set of normalized attention scores for the position; and
selecting an output for the position based on the normalized attention scores and the updated decoder RNN hidden state for the position in the output order.

10. The method of claim 9, further comprising combining the encoder RNN hidden states in accordance with the normalized attention scores to obtain a combination of encoder RNN hidden states for the position, and generating a next decoder RNN hidden state for a next position in the output order by combining the combination of encoder RNN hidden states for the position with the updated decoder RNN hidden state.

11. The method of claim 1, wherein each of the encoder RNN and the decoder RNN is a long short-term memory (LTSM) neural network.

12. The method of claim 1, wherein each of the encoder RNN and the decoder RNN is a gated recurrent unit (GRU) neural network.

13. The method of claim 1, wherein a first input in the source sequence is a designated start-of-sequence placeholder input.

14. The method of claim 1, wherein the processing of the respective encoder hidden states terminates when the decoder RNN produces a designated end-of-sequence placeholder output.

15. The method of claim 1, further comprising outputting a text-based description of each of one or more classes in the multi-level hierarchical classification taxonomy corresponding to one or more of the outputs in the produced sequence of outputs.

16. A system comprising one or more computers and one or more storage devices storing instructions that, when executed by the one or more computers, cause the one or more computers to perform operations comprising:
processing a source sequence of inputs corresponding to an input text block with an encoder recurrent neural network (RNN) to generate a respective encoder hidden state for each input;
processing the respective encoder hidden states with a decoder RNN to produce a sequence of outputs representing a classification path in a multi-level hierarchical classification taxonomy for the input text block;
wherein the sequence of outputs is produced, in an output order, from a predetermined vocabulary of outputs representing respective class nodes in a directed acyclic graph representation of the multi-level hierarchical classification taxonomy.

17. The system of claim 16, wherein the directed acyclic graph representation of the multi-level hierarchical classification taxonomy is a rooted tree, and each current output to be predicted at each successive position in the output order corresponds to a respective successive level in the hierarchical classification taxonomy.

18. The system of claim 16, wherein:
the one or more storage devices store classification data comprising a trained neural network classification model that includes a neural network trained to map the input text block to an output classification corresponding to the sequence of outputs according to the multi-level hierarchical classification taxonomy; and
processing the source sequence of inputs comprises using the trained neural network classification model to generate the respective encoder hidden state for each input; and processing the sequence of outputs comprises using the trained neural network classification model to produce the sequence of outputs representing a classification path in the multi-level hierarchical classification taxonomy for the input text block.

19. One or more non-transitory computer storage media encoded with a computer program product comprising instructions that, when executed by one or more computers, cause the one or more computers to perform operations comprising:
processing a source sequence of inputs corresponding to an input text block with an encoder recurrent neural network (RNN) to generate a respective encoder hidden state for each input;
processing the respective encoder hidden states with a decoder RNN to produce a sequence of outputs representing a classification path in a multi-level hierarchical classification taxonomy for the input text block;
wherein the sequence of outputs is produced, in an output order, from a predetermined vocabulary of outputs representing respective class nodes in a directed acyclic graph representation of the multi-level hierarchical classification taxonomy.

20. The one or more non-transitory computer storage media of claim 19, wherein the directed acyclic graph representation of the multi-level hierarchical classification taxonomy is a rooted tree, and each current output to be predicted at each successive position in the output order corresponds to a respective successive level in the hierarchical classification taxonomy.
